(19) United States
(12) Patent Application Publication
(10) Pub. No.: US 2009/0026725 A1
(43) Pub. Date: Jan. 29, 2009

(54) Wheel Suspension for a Motor Vehicle

(76) Inventors: Felix Haeusler, Osnabruck (DE); Metin Ersoy, Walluf (DE); Martin Taboada, Munchen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/162,831

(22) PCT Filed: Jan. 31, 2007
(86) PCT No.: PCT/DE07/00202

§ 371 Date: Jul. 31, 2008

(30) Foreign Application Priority Data
Feb. 1, 2006 (DE) 10 2006 004 959.4

(51) Int. Cl. B60G 3/18; B60G 3/26; B60G 7/00

(52) U.S. Cl. 280/124.135

(57) ABSTRACT

A wheel suspension is provided for a motor vehicle with a vehicle wheel (1), which is fastened to a wheel carrier (2), wherein the wheel carrier (2) is connected to the vehicle body (5) via a first control arm (3) and a second control arm (4), which are arranged at spaced locations from one another at the wheel carrier (2) and extend in a mutually intersecting arrangement.

The wheel suspension has a rotary control arm (6), which is connected to the vehicle body (5) in an articulated manner and which is connected to the vehicle body-side end of the first control arm (3) and, via at least one coupling member (10, 10a, 10b, 10c), to the wheel carrier (2) and/or to the wheel carrier-side end of the second control arm (4).

### CROSS REFERENCE TO RELATED APPLICATIONS

This application is a United States National Phase application of International Application PCT/DE2007/000202 and claims the benefit of priority under 35 U.S.C. § 119 of German Patent Application DE 10 2006 004 959.4 filed Feb. 1, 2006, the entire contents of which are incorporated herein by reference.

### FIELD OF THE INVENTION

The present invention pertains to a wheel suspension for a motor vehicle with a vehicle wheel, which is fastened to a wheel carrier, wherein said wheel carrier is connected to said vehicle body via a first control arm and a second control arm, which are arranged at spaced locations from one another at said wheel carrier and extend in a mutually intersecting arrangement

### BACKGROUND OF THE INVENTION

Increasingly strict requirements have been imposed on the chassis of modern motor vehicles. Thus, greater accelerations and higher top velocities and higher velocities of driving in curves also entail higher safety requirements, and growing needs for comfort must be taken into account as well.

Single-wheel suspensions (half shafts) have increasingly come into use in motor vehicles because of their comparatively small space requirement, the lower weight and the fact that the wheels of the vehicle hardly affect each other. Low weight and negligible mutual effects of the wheels of the vehicle on one another, in particular, represent decisive advantageous properties of the single-wheel suspensions for road grip and during driving in curves with uneven road surface.

The king pin angle of the vehicle wheels, which is given, for example, during driving in a curve, plays an important role for directional stability and also for the life of the tires. The wheel of the vehicle that is the outer wheel in the curve always has a positive king pin angle. Attempts are made in prior-art axle kinematics to counteract the positive king pin angle of the vehicle wheel that is the outer wheel in the curve by applying an opposing motion by the wheel of the vehicle being brought into the direction of a negative king pin angle during inward deflection. One possibility of achieving this, for example, in a double wishbone wheel suspension is to make the upper wishbone shorter than the lower wishbone. If a parallel arrangement of the wishbone planes is favored, the inwardly acting lateral force generates pressing forces in the lower wishbones and tensile forces in the upper wishbones. However, this force couple causes a torque, which additionally increases the slope of the body (roll) generated by the centrifugal force in a curve, to develop at the vehicle body.

The tendency of the single-wheel suspension to enhance especially the roll of the vehicle is counteracted by the use of a stabilizer, which couples with one another the wheels of the vehicle that are located opposite each other, but it at least partly eliminates the advantages of the single-wheel suspension.

A wheel suspension must be able to optimally guide the motor vehicle, i.e., to hold it in its track and not to transmit forces and torques generated during braking and start as well as in curves or due to unevennesses of the road surfaces to the vehicle body or to transmit these in a greatly reduced form only in order to reduce or prevent roll or pitching of the vehicle body.

To reduce the tendency of a vehicle to roll, it is known that wishbones can be provided in a mutually intersecting arrangement. Thus, U.S. Pat. No. 6,173,978 B1 shows a wheel suspension for a motor vehicle with a vehicle wheel, which is attached to a wheel carrier. The wheel carrier is connected in this embodiment to the vehicle body via at least two control arms, which are arranged spaced from one another at the wheel carrier and extend in a mutually intersecting arrangement. The intersecting of the control arms in space can be illustrated by a projection of the control arms onto a common plain, because the intersecting does not mean that the control arms are connected to one another at the point of intersection.

Such a wheel suspension has the drawback that a relatively short instantaneous pole radius is formed. The change in the king pin angle and hence also the change in the track width of the wheels are very great during the inward and outward excursions of the wheels. Moreover, such a solution leads to considerable problems in terms of the directional stability of the vehicle on a road section with an uneven road surface, and it is therefore necessary to accept reduced driving safety and reduced comfort here. Moreover, it was possible to observe that a force component, which causes the wheel suspension to lift off, on the whole, from the road surface, is brought about during driving in a curve in case of an intersected arrangement of the wishbones according to U.S. Pat. No. 6,173,978 B1. Such serious shortcomings in terms of safety develop especially in case of sudden steering motions and at higher velocities and cannot, of course, be accepted.

### SUMMARY OF THE INVENTION

The basic object of the present invention is to provide a wheel suspension for a motor vehicle, which has the advantages of mutually intersecting control arms but avoids the drawbacks of such an arrangement of the control arms and leads, in particular, to slight changes in the king pin angle and to a reduced tendency of the vehicle body to roll during the inward excursion of a vehicle wheel.

To accomplish the object described above, according to the present invention, a wheel suspension for a motor vehicle with a vehicle wheel, which is attached to a wheel carrier, is perfected by providing the wheel carrier connected to the vehicle body via at least two control arms, which are arranged at spaced locations from one another and extend in a mutually intersecting arrangement, such that the wheel suspension has a rotary control arm, which forms a connection by means of a coupling member between the vehicle body-side end of the first control arm and the wheel carrier and/or the wheel carrier-side end of the second control arm.

An inward deflection component, which increases driving safety, because it counteracts the lifting off of the vehicle wheel from the road surface, is now generated by a lateral force acting on the wheel of the vehicle.

The mutually intersecting control arms have an arrangement in space which, projected onto a common plane, shows a mutually intersecting shape when viewed from a direction of view at right angles to that plane.

The rolling motions of the vehicle body during driving in a curve are not fully eliminated with a solution according to the present invention, but they are at least reduced very substantially. The prior-art drawbacks already mentioned in the introduction, which occur in wheel suspensions with intersecting control arms, such as losses concerning driving safety and comfort, are avoided with the present invention. A wheel suspension is made available, which leads to a passive adjustment of the kinematic point of the vehicle body-side connection point of one of the control arms of the wheel suspension. Consequently, the body-side connection point of the first control arm of the wheel suspension is not fastened directly to the vehicle body, i.e., for example to the subframe or to the chassis, but to a rotary control arm, which in turn establishes a connection to the wheel carrier via a coupling member.

A very essential advantage of the present invention is especially that besides the reduction of the tendency of the vehicle body to roll, it is possible to eliminate altogether the stabilizer, which is usually necessary in single-wheel suspensions to connect the two mutually opposite wheel sides in order to achieve, for example, stabilization of the vehicle body during driving in curves, which was mentioned in the introduction. Thus, a cost-intensive component can be eliminated, which reduces the manufacturing costs of a wheel suspension according to the present invention as a whole. The elimination of the stabilizer necessary in usual single-wheel suspensions also leads, of course, to considerable reductions in the weight of the motor vehicle with the advantages resulting therefrom.

The reduction or elimination of the king pin angle of the vehicle wheels leads to a decisively reduced risk in extreme driving situations. Moreover, disturbing effects, which may develop during straight-line driving on uneven road surfaces due to changes in the king pin angle and the track width, can be avoided. The contact surface between the vehicle tire and the road surface is optimized in such a design. This in turn leads to improved static friction and hence to an increase in the driving safety of the vehicle.

According to a very simple embodiment variant of the present invention, the rotary control arm may be a wishbone having three connection points. A complicated mechanism for connecting the control arms is avoided due to the use of such a wishbone. A rocker pendulum may be used as a coupling member.

Another highly advantageous variant of the present invention can be seen in the use of a plurality of coupling members, which together form a deflecting linkage. The changes in the king pin angle at the vehicle wheel can be nearly completely eliminated with such a design. The vehicle wheel thus has an optimal contact with the road surface at any time and even in extreme situations and thus it increases the safety of the vehicle as a whole.

Since the individual coupling members of the deflecting linkage must be connected movably to one another, it is advantageous if suitable joints are used here. A sufficient selection of joints is available in the state of the art. Joints, such as ball sleeve joints, rotary slide bearings, sleeve-type rubber springs or other elastomer bearings shall be mentioned as examples only. The joints have one degree of freedom or two degrees of freedom.

Just as articulated connections are provided in the deflecting linkages, it is meaningful to also connect the rotary control arms to the vehicle body in an articulated manner. This also applies to the second control arm, which should be connected to the vehicle body on the vehicle body side via a joint.

Wishbones of a conventional design can be advantageously used as control arms for a wheel suspension in a solution according to the present invention. The wheel suspension presented is an single-wheel suspension, which is designed as a multiple control arm.

The present invention will be explained in more detail below on the basis of the drawings attached. The exemplary embodiments shown do not represent any limitation to the variants being shown, but are used only to explain some principles of wheel suspensions according to the present invention. Identical components or very similar components are designated by the same reference numbers. To make it possible to illustrate the mode of action according to the present invention, the figures show only highly simplified schematic views, in which components that are not essential for the present invention, such as springs, absorbers and other wheel suspension components, are not shown. However, this does not mean that such components are not present in a wheel suspension according to the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view showing a non-deflected wheel suspension, in which the wheel carrier-side end of the coupling member and the wheel carrier-side end of the second control arm are articulated to a common axis;

FIG. 2 is a schematic view showing a wheel suspension according to FIG. 1 during driving in a curve;

FIG. 3 is a schematic view showing a non-deflected wheel suspension with an arrangement of the rotary control arm that is different from the design shown in FIGS. 1 and 2;

FIG. 4 is a schematic view showing a non-deflected wheel suspension, in which the wheel carrier-side end of the coupling member and the wheel carrier-side end of the second control arm are articulated to different axes;

FIG. 5 is a schematic view showing a wheel suspension according to FIG. 4 during driving in a curve;

FIG. 6 is a schematic view showing a non-deflected wheel suspension with an arrangement of the rotary control arm that is different from the design shown in FIGS. 4 and 5;

FIG. 7 is a schematic view showing a non-deflected wheel suspension, in which the wheel carrier-side end of the second control arm is connected to the coupling member and the wheel carrier-side end of the coupling member as well as the wheel carrier-side end of the second control arm are articulated to different axes;

FIG. 8 is a schematic view showing a non-deflected wheel suspension with an arrangement of the rotary control arm that is different from the design shown in FIG. 7;

FIG. 9 is a schematic view showing a wheel suspension with a deflecting linkage during straight-line driving, in which the wheel carrier-side end of the coupling member and the wheel carrier-side end of the second control arm are articulated to a common axis;

FIG. 10 is a schematic view showing a wheel suspension according to FIG. 9 with a deflecting linkage during driving in a curve;

FIG. 11 is a schematic view showing a non-deflected wheel suspension with a deflecting linkage with an arrangement of the rotary control arm that is different from the design shown in FIGS. 9 and 10;

FIG. 12 is a schematic view showing a wheel suspension with a deflecting linkage during straight-line driving, in which the wheel carrier-side end of a coupling member and the wheel carrier-side end of the second control arm are articulated to different axes;

FIG. 13 is a schematic view showing a wheel suspension according to FIG. 12 with a deflecting linkage during driving in a curve;

FIG. 14 is a schematic view showing a non-deflected wheel suspension with a deflecting linkage with an arrangement of the rotary control arm that is different from the device shown in FIG. 13;

FIG. 15 is a schematic view showing a non-deflected wheel suspension with a deflecting linkage, in which the wheel carrier-side end of the second control arm is connected to a coupling member and the wheel carrier-side end of the coupling member as well as the wheel carrier-side end of the second control arm are articulated to different axes; and

FIG. 16 is a schematic view showing a non-deflected wheel suspension with a deflecting linkage with an arrangement of the rotary control arm that is different from the design according to FIG. 15.

### DESCRIPTION OF THE PREFERRED EMBODIMENTS

It shall be pointed out at the beginning that whenever a connection of components to the vehicle body 5 is referred to below, the fastening to the vehicle body may be carried out either directly or indirectly, an indirect connection being defined as the arrangement, for example, on a subframe.

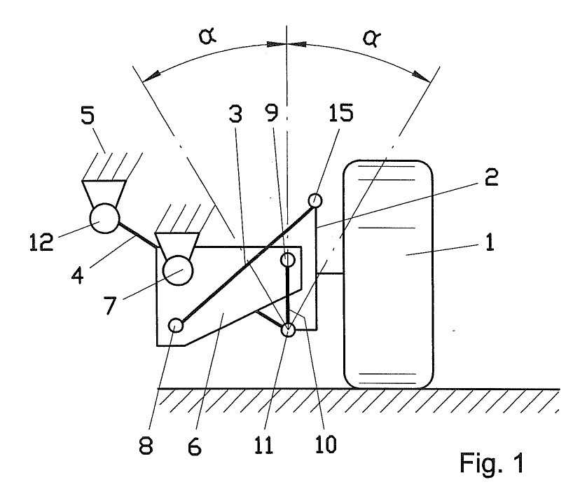

When viewed in the longitudinal direction of the vehicle, FIG. 1 shows a wheel suspension for a motor vehicle according to a first embodiment variant of the present invention in a simplified view. This wheel suspension has a vehicle wheel 1, which is attached to a wheel carrier 2. The vehicle wheel 1 is in a non-deflected position, as it would become established, for example, during straight-line driving of the vehicle. Two control arms 3 and 4 in a mutually intersecting arrangement extend between the wheel carrier 2 and the vehicle body 5. Since the view of the single-wheel suspension being shown here is a three-dimensional arrangement of the control arms, the mutually intersecting arrangement of the control arms is clearer when the control arms are projected onto an imaginary, common plane. The control arms 3 and 4 are connected to the wheel carrier 2 via respective hinges 11 and 15. A coupling is created between the control arms 3 and 4 by a rotary control arm 6 and a coupling member 10. The rotary control arm 6 is advantageously a wishbone equipped with three connection points 7, 8, 9. The connection points 7, 8, 9 are designed as hinges, the first control arm 3 extending, starting from its hinge 15 present in the upper part of the wheel carrier 2, to the hinge 8 of the wishbone 6. The wishbone 6 is mounted movably on the vehicle body via hinge 7.

The third hinge 9 of the wishbone 6 is connected via a coupling member 10 to the wheel carrier-side end of the control arm 4 and to the wheel carrier 2. At least one hinge 11 is present at this connection point between the coupling member 10 and the control arm 4, and the coupling member 10 and the second control arm 4 may also be arranged by means of two hinges 11 (and 11′, not shown) located on a common axis. The vehicle body-side end of the control arm 4 is arranged on the vehicle body 5 by means of a hinge 12.

The coupling member 10 is directed approximately vertically in a non-deflected position in the view shown. The angles indicated in FIG. 1 illustrate an area of installation of the coupling member 10, which is also considered to be approximately vertical in the sense of the present invention and may equal, for example, ±30°.

The wishbone 6 thus creates a connection between the vehicle body-side end of the first control arm 3 and the wheel carrier-side end of the second control arm 4 or the wheel carrier 2 by means of a coupling member 10.

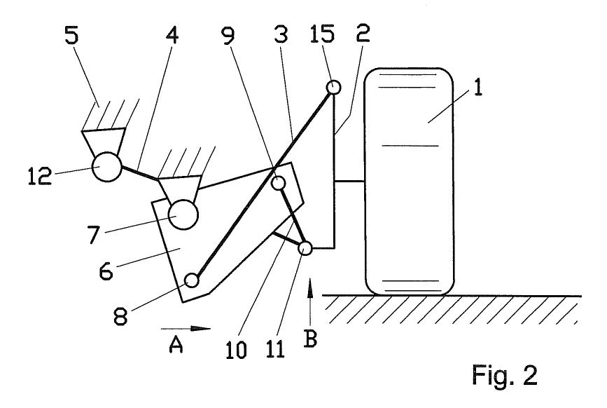

The components in the view shown in FIG. 2 correspond exactly to those of FIG. 1 described above. However, contrary to FIG. 1, FIG. 2 shows a deflected position of the vehicle wheel 1 of a wheel suspension, as it becomes established, for example, during driving in a curve. It can be recognized that the vehicle wheel 1 does not lift off from the ground. This effect of avoiding a king pin angle represents a considerable increase in comfort and in the safety of the vehicle. Furthermore, FIG. 2 shows how the motions of the control arms 3, 4 and of the wishbone 6 take place during driving in a curve. Thus, arrow A in FIG. 2 indicates the motion of the articulation point 8 between the wishbone 6 and the first wishbone 3 and arrow B shows the motion of the articulation point 11 of the second wishbone 4. The vehicle body-side end of the control arm 3 with the articulation point 8 migrates outwardly in the direction of arrow A, i.e., in the direction of the vehicle wheel 1, while the wheel carrier-side end 11 of control arm 4 performs an upward motion in the direction of arrow B shown in FIG. 2. A considerably smaller king pin angle is thus generated than was the case in the hitherto known embodiments of single-wheel suspensions.

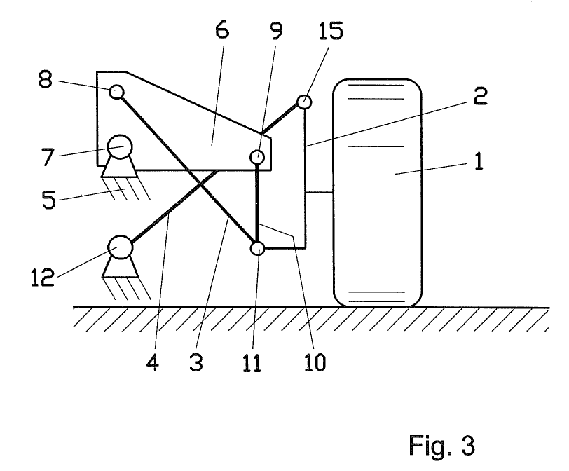

A simplified view of a non-deflected wheel suspension with an arrangement of the rotary control arm 6 that is different from the design shown in FIGS. 1 and 2 is shown in FIG. 3. In this design variant of a wheel suspension, the wheel carrier-side part of the first control arm 3 is attached movably to the wheel carrier 2 via the hinge 11, while the wheel carrier-side end of the second control arm 4 is deflected at the hinge 15 in wheel carrier 2. A coupling member 10, which is designed as a rocker pendulum here, is located between the hinge 11 and the connection point 9 of the rotary control arm 6. The rotary control arm 6 designed as a wishbone is connected to the vehicle body 5 via the hinge 7 and to the vehicle body-side end of the first control arm 3 via the hinge 8. The vehicle body-side end of the second control arm 4 has a connection to the vehicle body 5 in hinge 12.

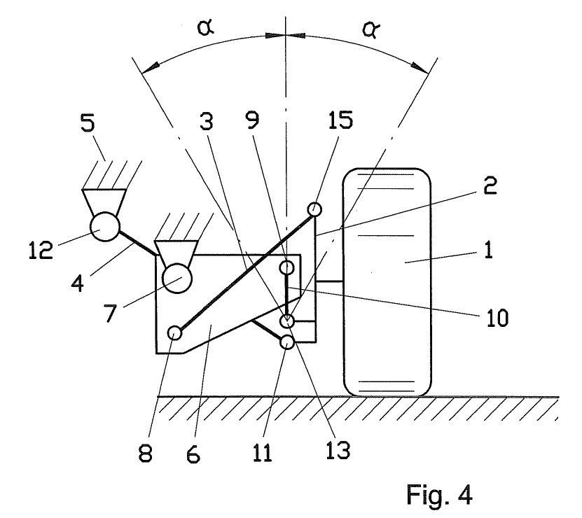

While the coupling member 10 and the wheel carrier-side end of the second control arm 4 are connected on a common axis extending through the hinge point 11 in the variant of a wheel suspension shown in FIG. 1, the wheel suspension in FIG. 4, which otherwise has the same design, shows an embodiment in which the coupling member 10 is connected to the wheel carrier 2 via another hinge 13 and the wheel carrier-side end of the second control arm 4 is connected to the wheel carrier 2 via hinge 11. The coupling member 10 and the wheel carrier-side end of the control arm 4 are not arranged on a common axis here. In the view, the coupling member 10 is directed approximately vertically in a non-deflected position. The angles indicated in FIG. 4 illustrate an area of installation of the coupling member 10, which is also considered to be approximately vertical in the sense of the present invention and may equal, for example, ±30°.

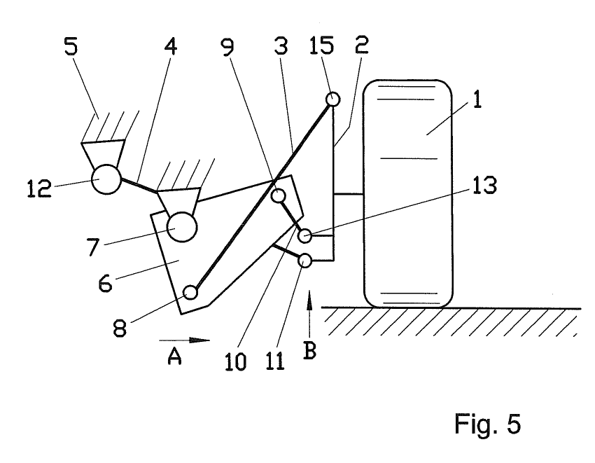

FIG. 5 shows a deflected wheel suspension according to the embodiment variant shown in FIG. 4. Arrow A indicates here the motion of the hinge point 8 and arrow B the direction of motion of the hinge point 11.

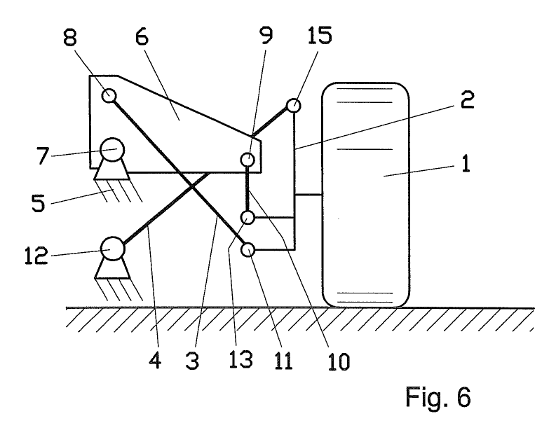

FIG. 6 shows a simplified view of a non-deflected wheel suspension with an arrangement of the rotary control arm 6 that is different from the design shown in FIGS. 4 and 5. The wheel carrier-side part of the first control arm 3 is fastened here movably to the wheel carrier 2 via the hinge 11, while the wheel carrier-side end of the second control arm 4 is articulated in hinge 15 at the wheel carrier 2. A coupling member 10, which is designed as a rocker pendulum here, is located between a hinge 13 of the wheel carrier 2 and the connection point 9 of the rotary control arm 6. The rotary control arm 6, designed as a wishbone, is connected to the vehicle body 5 via hinge 7 and to the vehicle body-side end of the first control arm 3 via hinge 8. The vehicle body-side end of the second control arm 4 has in the hinge 12 a connection to the vehicle body 5. The vehicle wheel-side end of the first control arm 3 and the wheel carrier-side end of the coupling member 10 are connected in this variant to the associated hinges 11 and 13, respectively, on different axes.

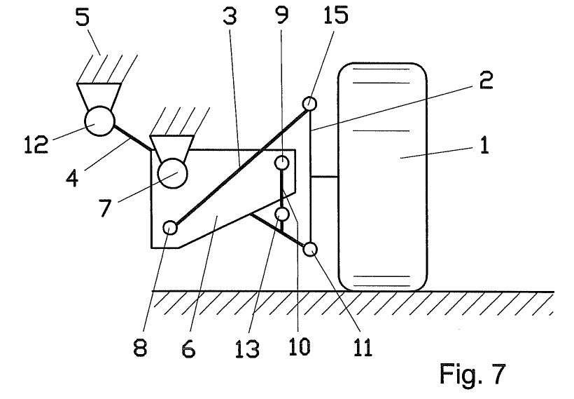

FIG. 7 shows another example of a feasible variant of the present invention on the basis of a simplified view of a non-deflected wheel suspension, in which the wheel carrier-side end of the second control arm 4 is connected to the coupling member 10 and the wheel carrier-side end of the coupling member 10 as well as the wheel carrier-side end of the second control arm 4 are articulated to different axes. As was described above, these axes extend through the respective hinges 11 and 13.

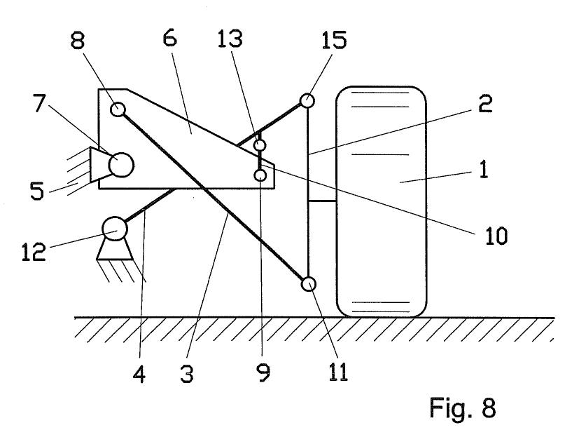

By contrast, FIG. 8 shows a wheel suspension, which has, in principle, the same design as that in FIG. 7. Contrary to FIG. 7, the arrangement of the rotary control arm 6 is different in this non-deflected wheel suspension in respect to the vehicle body 5.

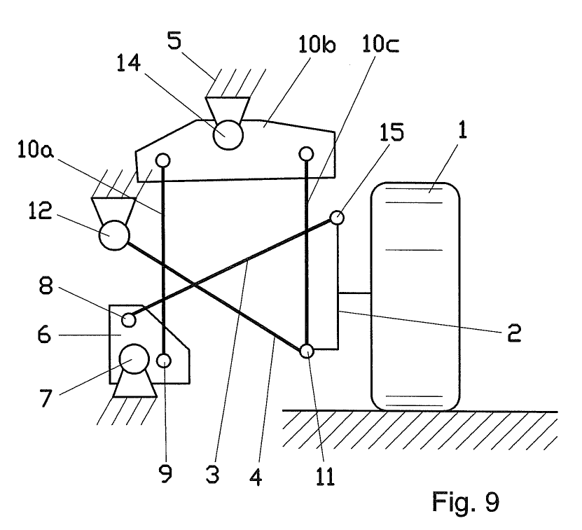

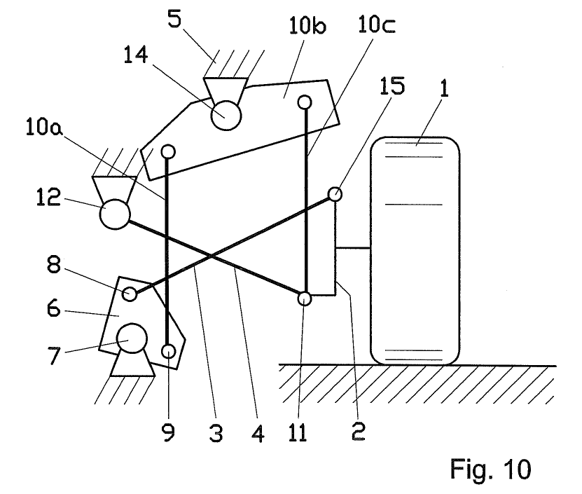

FIG. 9 shows a non-deflected wheel suspension and FIG. 10 a deflected wheel suspension of a special embodiment variant of the present invention. The wheel suspension in FIG. 9 has, in turn, a vehicle wheel 1, which is held by means of a wheel carrier 2. A first control arm 3 and a second control arm 4 are arranged at the wheel carrier 2 in a mutually intersecting arrangement. The vehicle body-side end of the control arm 4 is fastened movably to the vehicle body 5 via a hinge 12. The vehicle body-side end of the control arm 3 has a connection to the rotary control arm 6 designed as a wishbone. This connection point 8 between the control arm 3 and the wishbone 6 is designed as a hinge. The wishbone 6 is fastened to the vehicle body 5 by means of the hinge 7. Not only is an individual coupling member arranged, as this was described above, at the hinge point 9 of the wishbone 6 in the view shown in FIG. 9. A plurality of coupling members 10a, 10b, 10c, which together form a deflecting linkage, are used in this case. This deflecting linkage comprises three individual elements; these are the coupling members 10a, 10b and 10c, and the coupling members 10a, 10b and 10c are connected to one another in an articulated manner. The middle coupling member 10b is arranged at the vehicle body 5 via a hinge connection 14.

It is remarkable in FIG. 10 that no king pin angle can be observed in the vehicle wheel 1 even during driving in a curve.

FIG. 10 shows a “deflected” variant of a vehicle wheel, as this would become established, for example, during driving in a curve. The vehicle wheel has complete road grip and does not lift off. As is also apparent from FIG. 10, hinge 9 of the wishbone 6 migrates in an approximately vertical direction due to rotation of the wishbone 6 about the hinge 7, so that the coupling member 10b is pivoted about joint 14 and coupling member 10c will thus evade in an opposite direction. Coupling member 10c consequently moves upwardly in the view shown in FIG. 10. Due to the coupling member 10c being arranged at the wheel carrier-side end 11 of control arm 4 or at the wheel carrier 2, the oblique position (king pin angle) usually becoming established at the vehicle wheel 1 during driving in a curve is fully compensated.

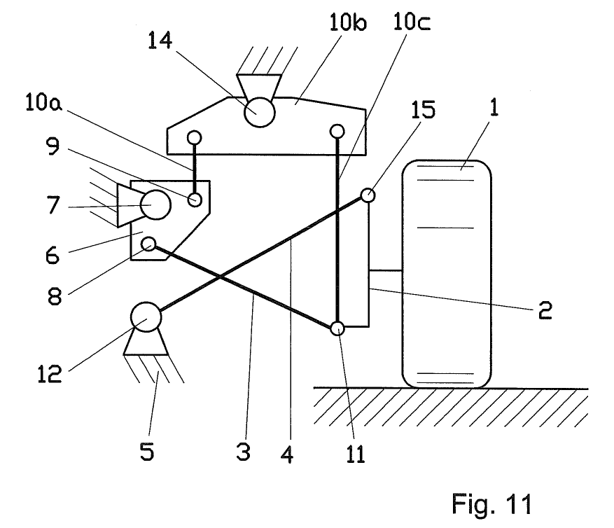

FIG. 11 shows a simplified view of a non-deflected wheel suspension with a deflecting linkage with an arrangement of the rotary control arm 6 that is different from the design shown in FIGS. 9 and 10.

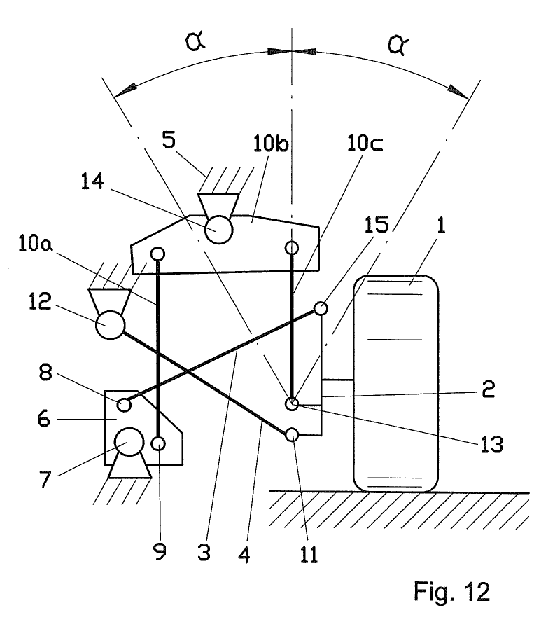

The wheel suspension shown in FIG. 12 is likewise provided with a deflecting linkage and is shown during straight-line travel. The wheel carrier-side end of the coupling member 10c and the wheel carrier-side end of the second control arm 4 are articulated to different axes. The axes extend through the hinges 11 and 13, respectively. FIG. 12 should be seen as an alternative solution to the wheel suspension according to FIG. 9, which otherwise has the same design. Coupling member 10c has here in the joint 13 a connection with the wheel carrier 2, whereas the wheel carrier-side end of the second control arm 4 is coupled with the wheel carrier 2 in the hinge 11. The coupling member 10c is installed approximately vertically. An angle of, e.g., ±30° is, however, permissible as a deviation tolerance.

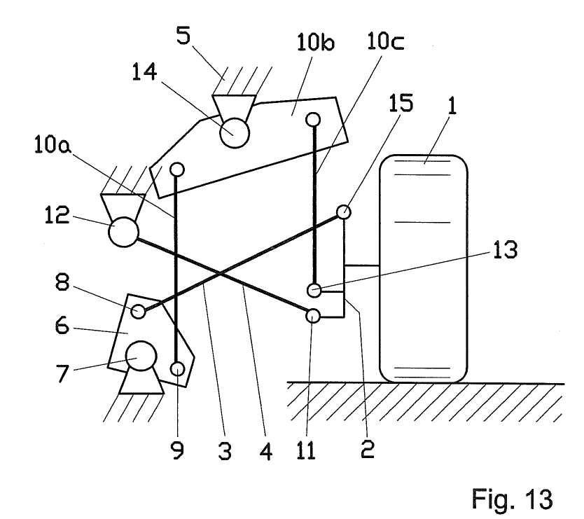

FIG. 13 shows a wheel suspension according to FIG. 12 with a deflecting linkage during driving in a curve. No king pin angle of the vehicle wheel 1 is seen any longer in this variant, either.

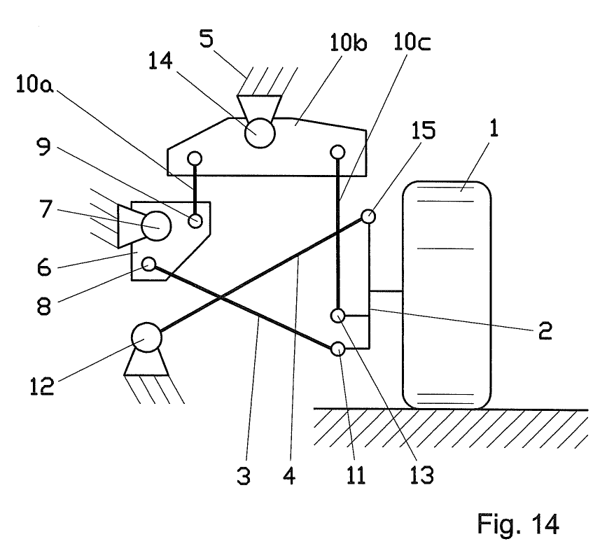

FIG. 14 shows a simplified view of a non-deflected wheel suspension with a deflecting linkage with an arrangement of the rotary control arm 6 that is different from the design shown in FIG. 13.

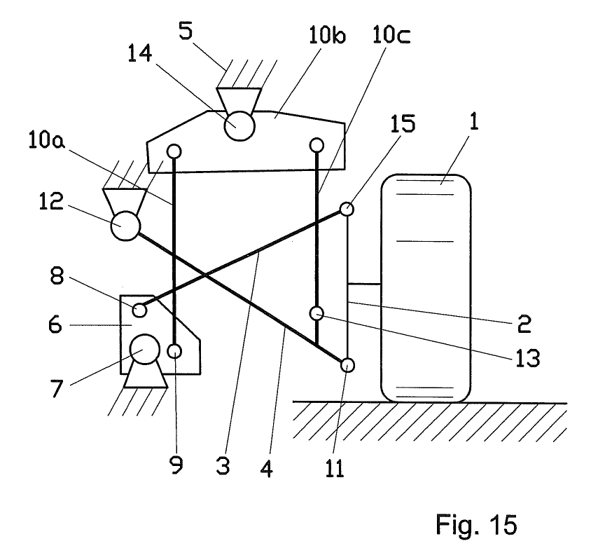

FIG. 15 shows a non-deflected wheel suspension with a deflecting linkage, in which the wheel carrier-side end of the second control arm 4 is connected to a coupling member 10c, and the wheel carrier-side end of the coupling member 10c as well as the wheel carrier-side end of the second control arm 4 are articulated on different axes, which extend through the hinges 11 and 13.

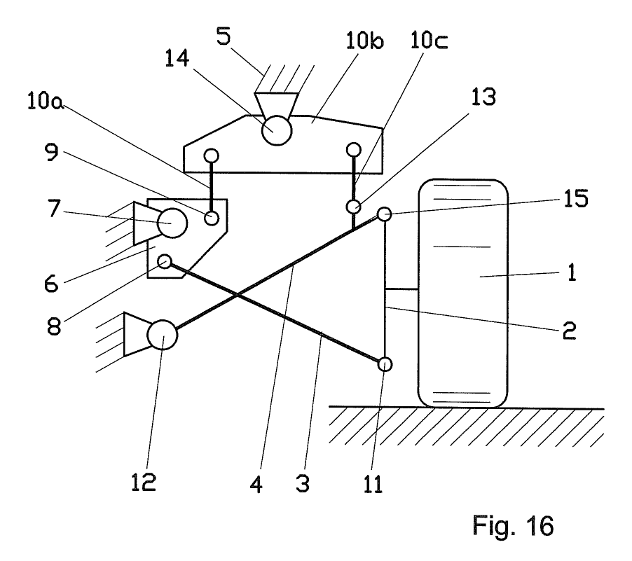

FIG. 16 shows a simplified view of a non-deflected wheel suspension with a deflecting linkage with an arrangement of the rotary control arm 6 that is different from the design shown in FIG. 15.

While specific embodiments of the invention have been shown and described in detail to illustrate the application of the principles of the invention, it will be understood that the invention may be embodied otherwise without departing from such principles.

1-13. (canceled)

14. A motor vehicle wheel suspension for a vehicle wheel fastened to a wheel carrier, wherein said wheel carrier is connected to a vehicle body via the motor vehicle wheel suspension, the motor vehicle wheel suspension comprising:
a first control arm;
a second control arm, said first control arm and said second control arm being arranged at spaced locations from each other at said wheel carrier and said first control arm and said second control arm extending in a mutually intersecting arrangement;
a rotary control arm connected to the vehicle body in an articulated manner, said rotary control arm being connected to a vehicle body-side end of said first control arm and said rotary control arm being connected to at least one of said wheel carrier and a wheel carrier-side end of said second control arm via a coupling member.

15. A motor vehicle wheel suspension in accordance with claim 14, wherein said rotary control arm is a wishbone having three connection points.

16. A motor vehicle wheel suspension in accordance with claim 14, wherein said coupling member is a rocker pendulum.

17. A motor vehicle wheel suspension in accordance with claim 14, wherein at least an additional coupling member is provided wherein said coupling member and said additional coupling member provide a plurality of coupling members forming a deflecting linkage.

18. A motor vehicle wheel suspension in accordance with claim 17, wherein at least one coupling member of said deflecting linkage has a hinge for connection to said vehicle body.

19. A motor vehicle wheel suspension in accordance with claim 17, wherein said plurality of coupling members of said deflecting linkage are connected to one another in an articulated manner.

20. A motor vehicle wheel suspension in accordance with claim 14, wherein said rotary control arm has a hinge for connection to said vehicle body.

21. A motor vehicle wheel suspension in accordance with claim 14, wherein said second control arm has a hinge on the vehicle body side fastening said second control arm to said vehicle body.

22. A motor vehicle wheel suspension in accordance with claim 14, wherein said first control arm and said second control arm are wishbones.

23. A motor vehicle wheel suspension in accordance with claim 14, wherein hinge connections between parts of the motor vehicle wheel suspension are joints or elastomer bearings.

24. A motor vehicle wheel suspension in accordance with claim 14, wherein said coupling member is directed approximately vertically in a neutral position, wherein an angle of incidence in relation to the vertical is at most ±30°.

25. A motor vehicle wheel suspension in accordance with claim 14, wherein said wheel suspension is part of a multiple control arm axle.

26. A motor vehicle wheel suspension in accordance with claim 14, wherein the motor vehicle wheel suspension only provides a connection from the wheel carrier to the vehicle body so as to define a single-wheel suspension.

27. A motor vehicle wheel suspension arrangement comprising:
a vehicle wheel fastened to a wheel carrier;
a vehicle body;
a first control arm;
a second control arm, said first control arm being arranged at a spaced location from said second control arm at said wheel carrier and said first control arm and said second control arm extending in a crosswise arrangement relative to each other;
a rotary control arm connected to said vehicle body in an articulated manner, said rotary control arm being connected to a vehicle body-side end of said first control arm and said rotary control arm being connected to at least one of said wheel carrier and a wheel carrier-side end of said second control arm via a coupling member.

28. A motor vehicle wheel suspension in accordance with claim 27, wherein said rotary control arm is a wishbone having three connection points.

29. A motor vehicle wheel suspension in accordance with claim 27, wherein said coupling member is a rocker pendulum.

30. A motor vehicle wheel suspension in accordance with claim 27, wherein at least an additional coupling member is provided wherein said coupling member and said additional coupling member provide a plurality of coupling members forming a deflecting linkage.

31. A motor vehicle wheel suspension in accordance with claim 27, wherein said rotary control arm has a hinge for connection to said vehicle body.

32. A motor vehicle wheel suspension in accordance with claim 27, wherein said second control arm has a hinge on the vehicle body side fastening said second control arm to said vehicle body.

33. A motor vehicle wheel suspension in accordance with claim 14, wherein the motor vehicle wheel suspension only provides a connection from the wheel carrier to the vehicle body so as to define a single-wheel suspension.
